(19) United States
(12) Patent Application Publication
(10) Pub. No.: US 2025/0392053 A1
(43) Pub. Date: Dec. 25, 2025

(54) INTELLIGENT REFLECTING SURFACE AND METHOD FOR DRIVING THE INTELLIGENT REFLECTING SURFACE

(71) Applicant: Japan Display Inc., Tokyo (JP)

(72) Inventor: Takanori TSUNASHIMA, Tokyo (JP)

(73) Assignee: Japan Display Inc., Tokyo (JP)

(21) Appl. No.: 19/313,923

(22) Filed: Aug. 29, 2025

Related U.S. Application Data
(63) Continuation of application No. PCT/JP2024/006736, filed on Feb. 26, 2024.

(30) Foreign Application Priority Data
Mar. 24, 2023 (JP) 2023-048273

(51) Int. Cl. H01Q 15/14

(52) U.S. Cl. CPC H01Q 15/147

(57) ABSTRACT

An intelligent reflecting surface includes a plurality of radio-wave reflection elements arranged in a matrix shape with m rows and n columns. Each of the plurality of radio-wave reflection elements includes a first electrode, a liquid crystal layer over the first electrode, and an electrically floated second electrode over the liquid crystal layer. A driving method of the intelligent reflecting surface includes providing the first electrode with a control potential with respect to a reference potential without providing a potential to the second electrode in a first frame period. A summation of the control potentials provided to the first electrodes of the plurality of radio-wave reflection elements is 0 V in the first frame period. m and n are independently selected from natural numbers equal to or greater than 6, and n is an even number.

### CROSS-REFERENCE TO RELATED APPLICATIONS

This application is a Continuation of International Patent Application No. PCT/JP2024/006736, filed on Feb. 26, 2024, which claims the benefit of priority to Japanese Patent Application No. 2023-048273, filed on Mar. 24, 2023, the entire contents of each are incorporated herein by reference.

### FIELD

An embodiment of the present invention relates to an intelligent reflecting surface and a driving method thereof.

### BACKGROUND

Since liquid crystal molecules have anisotropic permittivity, the permittivity of the liquid crystal layer can be controlled by adjusting the electric field applied to the liquid crystal layer containing liquid crystal molecules to control the orientation of the liquid crystal molecules. Metasurfaces utilizing such characteristics and capable of controlling reflectance characteristics of liquid crystal layers with respect to radio waves have been known (see Japanese Laid-Open Patent Publications No. H11-1032011 and 2019-5303872, for example).

### SUMMARY

An embodiment of the present invention is a driving method of an intelligent reflecting surface. The intelligent reflecting surface includes a plurality of radio-wave reflection elements arranged in a matrix shape with m rows and n columns. Each of the plurality of radio-wave reflection elements includes a first electrode, a liquid crystal layer over the first electrode, and an electrically floated second electrode over the liquid crystal layer. The driving method includes providing the first electrode with a control potential with respect to a reference potential without providing a potential to the second electrode in a first frame period. A summation of the control potentials provided to the first electrodes of the plurality of radio-wave reflection elements is 0 V in the first frame period. m and n are independently selected from natural numbers equal to or greater than 6, and n is an even number.

An embodiment of the present invention is an intelligent reflecting surface. The intelligent reflecting surface includes a plurality of radio-wave reflection elements arranged in a matrix shape with m rows and n columns. Each of the plurality of radio-wave reflection elements includes a first electrode, a liquid crystal layer over the first electrode, and an electrically floated second electrode over the liquid crystal layer. m and n are independently selected from natural numbers equal to or greater than 6, and n is an even number.

### BRIEF DESCRIPTION OF DRAWINGS

FIG. 1 is a schematic top view of an intelligent reflecting surface according to an embodiment of the present invention.

FIG. 2 is a schematic cross-sectional view of an intelligent reflecting surface according to an embodiment of the present invention.

FIG. 3A is a schematic plan view of a counter substrate of an intelligent reflecting surface according to an embodiment of the present invention.

FIG. 3B is a schematic cross-sectional view of a counter substrate of an intelligent reflecting surface according to an embodiment of the present invention.

FIG. 4 is a schematic top view of an intelligent reflecting surface according to an embodiment of the present invention.

FIG. 5 is a timing chart showing a driving method of an intelligent reflecting surface according to an embodiment of the present invention.

FIG. 6 is a schematic top view showing a driving method of an intelligent reflecting surface according to an embodiment of the present invention.

FIG. 7A is a schematic view showing a driving method of an intelligent reflecting surface according to an embodiment of the present invention.

FIG. 7B is a schematic view showing a driving method of an intelligent reflecting surface according to an embodiment of the present invention.

FIG. 8A is a schematic view showing a driving method of an intelligent reflecting surface according to an embodiment of the present invention.

FIG. 8B is a schematic view showing a driving method of an intelligent reflecting surface according to an embodiment of the present invention.

FIG. 8C is a schematic view showing a driving method of an intelligent reflecting surface according to an embodiment of the present invention.

FIG. 9A is a schematic view showing a driving method of an intelligent reflecting surface according to an embodiment of the present invention.

FIG. 9B is a schematic view showing a driving method of an intelligent reflecting surface according to an embodiment of the present invention.

FIG. 9C is a schematic view showing a driving method of an intelligent reflecting surface according to an embodiment of the present invention.

FIG. 10A is a schematic view showing a driving method of an intelligent reflecting surface according to an embodiment of the present invention.

FIG. 10B is a schematic view showing a driving method of an intelligent reflecting surface according to an embodiment of the present invention.

FIG. 10C is a schematic view showing a driving method of an intelligent reflecting surface according to an embodiment of the present invention.

FIG. 11A is a schematic view showing a driving method of an intelligent reflecting surface according to an embodiment of the present invention.

FIG. 11B is a schematic view showing a driving method of an intelligent reflecting surface according to an embodiment of the present invention.

FIG. 11C is a schematic view showing a driving method of an intelligent reflecting surface according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

### 1. Structure of Intelligent Reflecting Surface

Hereinafter, a structure of an intelligent reflecting surface according to an embodiment of the present invention is explained. The intelligent reflecting surface is a so-called liquid crystal metasurface reflector and is a device utilizing the permittivity change resulting from the orientation change of the liquid crystal layer caused by an electric field to reflect applied radio waves in arbitrary directions. There are no restrictions on the frequency of the radio waves which can be reflected, and the radio waves are in the range of 400 MHz to 50 GHZ, for example. Typically, the intelligent reflecting surface can be used to reflect radio waves in the 400 MHz to 6.0 GHz band, the 2.5 GHz to 4.7 GHz band, and the 24 GHz to 50 GHz band.

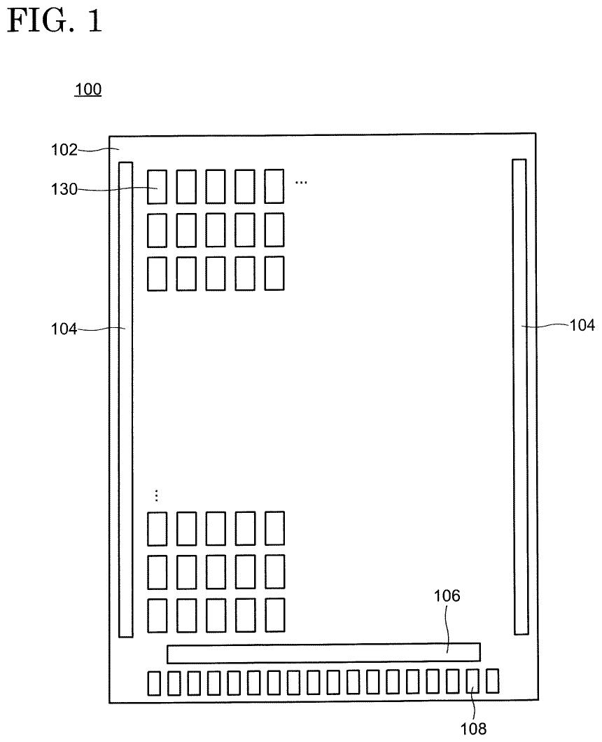

FIG. 1 shows a schematic top view of the intelligent reflecting surface 100. The intelligent reflecting surface 100 has a substrate 102 and a counter substrate which is not illustrated in FIG. 1 between which a variety of patterned insulating films, semiconductor films, and conductive films is formed. An appropriate stack of these films allows the formation of a plurality of radio-wave reflection elements 130 arranged in a matrix shape with m rows and n columns. In addition to the radio-wave reflection elements 130, the intelligent reflecting surface 100 has a gate-line driver circuit 104 and a signal-line driver circuit 106 for supplying a variety of signals to the radio-wave reflection elements 130. The gate-line driver circuit 104 and the signal-line driver circuit 106 may be fabricated with the insulating films, the semiconductor films, and the conductive films disposed over the substrate 102 or by mounting an integrated circuit formed over a semiconductor substrate over the substrate 102. The number of gate-line driver circuits 104 may be one or more, and in the latter case, two gate-line driver circuits 104 may be arranged over the substrate 102 so as to sandwich the plurality of radio-wave reflection elements 130 as shown in FIG. 1. The signal-line driver circuit 106 is placed on one edge side of the substrate 102. Here, m and n are independently selected from natural numbers greater than or equal to 6, where n is an even number.

A plurality of gate lines and a plurality of signal lines (not illustrated in FIG. 1) respectively extend from the gate-line driver circuit 104 and the signal-line driver circuit 106 and are electrically connected to the radio-wave reflection elements 130. A plurality of terminals 108 is further provided over the substrate 102, and a variety of signals for driving the radio-wave reflection elements 130 are supplied through the terminals 108 from an external circuit which is not illustrated. The gate-line driver circuit 104 and the signal-line driver circuit 106 generate gate signals and control potentials on the basis of the supplied signals and supply these signals to the radio-wave reflection elements 130.

### 2. Structure of Radio-Wave Reflection Element

### (1) Overall Structure

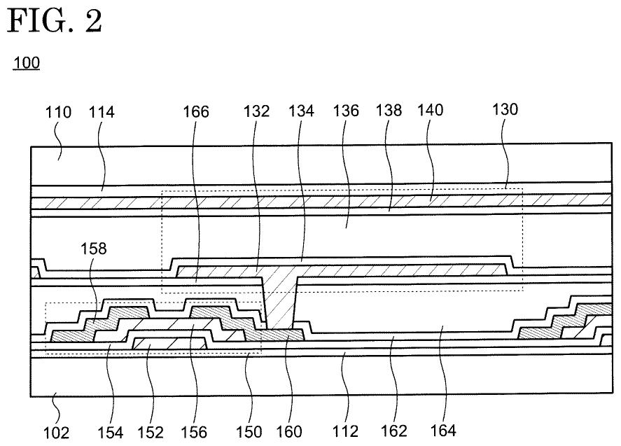

FIG. 2 shows a schematic view of a cross section of a part of the intelligent reflecting surface 100. Each of the radio-wave reflection elements 130 is connected to an element circuit including at least one transistor. Each element circuit may include a plurality of transistors and one or a plurality of capacitive elements. The example depicted in FIG. 2 shows one transistor 150, one radio-wave reflection element 130 connected thereto, and a part of adjacent radio-wave reflection element 130.

As can be understood from FIG. 2, the element circuit and the radio-wave reflection element 130 are provided over the substrate 102 either directly or through an undercoat 112 which is an optional component. The structure of the transistor included in the element circuit is not restricted, and the transistor may be either a bottom-gate transistor or a top-gate transistor. Alternatively, the transistor may be a transistor having gate electrodes over and under a semiconductor film. The transistor illustrated in FIG. 2 is a bottom-gate transistor and is composed of a gate electrode 152, a gate insulating film 154 over the gate electrode 152, a semiconductor film 156 over the gate insulating film 154, and a pair of terminals 158 and 160 over the semiconductor film 156. A leveling film 164 is provided over the transistor 150, and a radio-wave reflection element 130 is formed thereover. As an optional component, interlayer insulating films 162 and 166 may be respectively provided between the transistor 150 and the leveling film 164 and over the leveling film 164.

The radio-wave reflection element 130 has a first electrode (also called a patch electrode) 132, a first orientation film 134 over the first electrode 132, a liquid crystal layer 136 over the first orientation film 134, a second orientation film 138 over the liquid crystal layer 136, and a second electrode 140 over the second orientation film 138. The second electrode 140 is provided over the counter substrate 110 (below the counter substrate 110 in FIG. 2) directly or through an overcoat 114 which is an optional component. The first electrode 132 is electrically connected to the transistor 150 through an opening formed in the interlayer insulating film 162 and the leveling film 164, by which the control potential is supplied from the signal-line driver circuit 106 to the radio-wave reflection element 130. Hereinafter, these components are explained.

### (2) Substrate and Counter Substrate

The substrate 102 and the counter substrate 110 are provided to provide physical strength to the intelligent reflecting surface 100 and to provide a surface for arranging the radio-wave reflection elements 130. The substrate 102 and/or the counter substrate 110 may be flexible. The substrate 102 and the counter substrate 110 may include an inorganic insulator such as glass and quartz, a semiconductor such as silicon, a polymer such as a polyimide, a polycarbonate, and a polyester, and a metal such as aluminum, copper, and stainless steel. When a conductive material such as a metal is included, a film containing an insulator such as silicon oxide and silicon nitride is preferably disposed as the undercoat 112 and the overcoat 114 over the surfaces where the radio-wave reflection elements 130 are arranged, i.e., the surface of the substrate 102 on the counter substrate 110 side and the surface of the counter substrate 110 on the substrate 102 side. The substrate 102 and the counter substrate 110 may or may not transmit visible light.

### (3) Transistor

The gate electrode 152, the gate insulating film 154, the semiconductor film 156, the terminals 158 and 160 as well as the interlayer insulating films 162 and 166 and the leveling film 164 covering the transistor 150 may be fabricated by using known materials and applying known methods as appropriate. Therefore, a detailed description is omitted. In brief, the gate electrode 152 and the terminals 158 and 160 are formed by forming a film containing a metal such as tantalum, molybdenum, titanium, and aluminum with a sputtering method or a chemical vapor deposition (CVD) method followed by patterning this film as appropriate using a photolithographic process. The semiconductor film 156 is formed as a film containing a Group 14 element exemplified by silicon or a film containing an oxide of a Group 13 element such as indium and gallium. The semiconductor film 156 may also be formed by applying a sputtering method or a CVD method. The gate insulating film 154 and the interlayer insulating films 162 and 166 include a silicon-containing inorganic compound such as silicon oxide and silicon nitride and are formed by applying a sputtering method or a CVD method. The leveling film 164 includes a polymer such as an acrylic resin, an epoxy resin, a polyimide, a polyamide, and a silicon resin and may be formed by applying a wet film-forming method such as a spin coating method, an inkjet method, and a printing method as appropriate. The radio-wave reflection elements 130 can be formed over a flat surface by providing the leveling film 164.

### (4) Radio-Wave Reflection Element

The first electrode 132 of the radio-wave reflection element 130 includes, for example, a metal such as copper, aluminum, tungsten, molybdenum, and titanium or an alloy including at least one of these metals. Alternatively, the first electrode 132 may include a conductive oxide having a light-transmitting property such as indium-zinc oxide (IZO) and indium-tin oxide (ITO). The first electrode 132 may have a monolayer structure or a stacked-layer structure with layers of different compositions. For example, a stacked structure of a layer containing a conductive oxide and a layer containing the aforementioned metal or alloy may be employed. Alternatively, the first electrode 132 may have a mesh shape in order to provide a light-transmitting property to the intelligent reflecting surface 100 having the first electrodes 132 containing a metal or an alloy.

The first orientation film 134 disposed over the plurality of first electrodes 132 is provided to control the orientation of the liquid crystal molecules structuring the liquid crystal layer 136 arranged thereover. The first orientation film 134 may be provided continuously over the plurality of radio-wave reflection elements 130. In other words, the first orientation film 134 may be provided so as not to be divided between adjacent radio-wave reflection elements 130 and to be shared by all of the radio-wave reflection elements 130.

The first orientation film 134 includes a polymer such as a polyimide and a polyester. The first orientation film 134 is formed by utilizing a wet film-forming method such as an ink-jet method, a spin-coating method, a printing method, and a dip-coating method, and a surface thereof is subjected to a rubbing treatment. Alternatively, the first orientation film 134 may be formed by a photo-orientation treatment.

The liquid crystal layer 136 contains liquid crystal molecules. The structure of the liquid crystal molecules is not limited. Thus, the liquid crystal molecules may be nematic liquid crystals, smectic crystals, cholesteric crystals, or chiral smectic liquid crystals. A thickness of the liquid crystal layer 136 is, for example, equal to or greater than 20 μm and equal to or smaller than 50 μm or equal to or greater than 30 μm and equal to or smaller than 50 μm. Although not illustrated, a spacer may be provided in the liquid crystal layer 136 to maintain this thickness throughout the intelligent reflecting surface 100. When the aforementioned thickness of the liquid crystal layer 136 is employed in a liquid crystal display device, the high responsiveness required to display moving images cannot be obtained, and it becomes significantly difficult to express the functions of a liquid crystal display device.

The second orientation film 138 is also provided to control the orientation of the liquid crystal molecules and has the same configuration as the first orientation film 134. The second orientation film 138 may also be formed so as to be continuous over adjacent radio-wave reflection elements 130 and to be shared by the plurality of radio-wave reflection elements 130. The first orientation film 134 and the second orientation film 138 are arranged so that the direction in which the first orientation film 134 orients the liquid crystal molecules is parallel to that of the second orientation film 138. The liquid crystal molecules are oriented in a certain direction by the first orientation film 134 and the second orientation film 138.

Similar to the first electrode 132, the second electrode 140 may also include, for example, a metal such as copper, aluminum, tungsten, molybdenum, and titanium, an alloy containing at least one of these metals, or a conductive oxide such as ITO or IZO. The second electrode 140 may also have a monolayer structure or a stacked-layer structure in which layers of different compositions are stacked. The second electrode 140 may also be formed by applying a sputtering method, a CVD method, or the like. The second electrode 140 may be arranged for each of the radio-wave reflection elements 130 or may be provided as a single electrode integrated over the plurality of the radio-wave reflection elements 130 to be shared by the plurality of the radio-wave reflection elements 130.

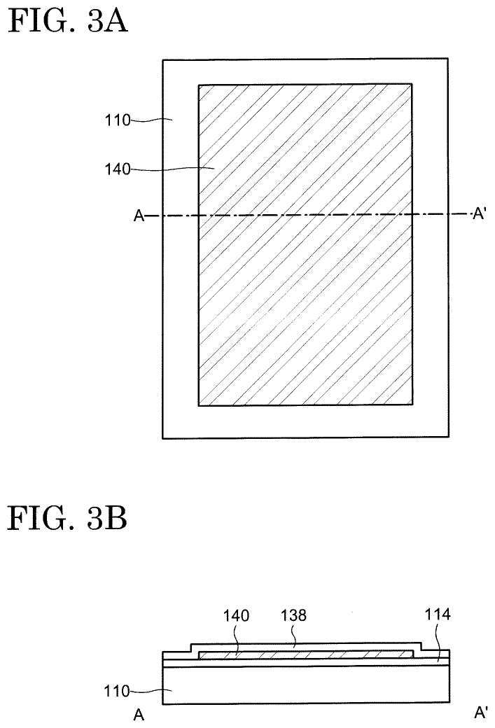

Here, in the intelligent reflecting surface 100, the second electrode 140 is electrically floated and is not supplied with any signal or potential from the external circuit. Therefore, as shown in the schematic plan view of the counter substrate 110 viewed from the substrate 102 side (FIG. 3A) and the schematic view of the cross section along the chain line A-A′ thereof (FIG. 3B), the second electrode 140 may be provided so as to be entirely encapsulated (sealed) between the counter substrate 110 and the second orientation film 138. When the overcoat 114 is provided, the second electrode 140 may be provided so as to be entirely encapsulated (sealed) between the overcoat 114 and the second orientation film 138.

### 3. Driving Method of Intelligent Reflecting Surface

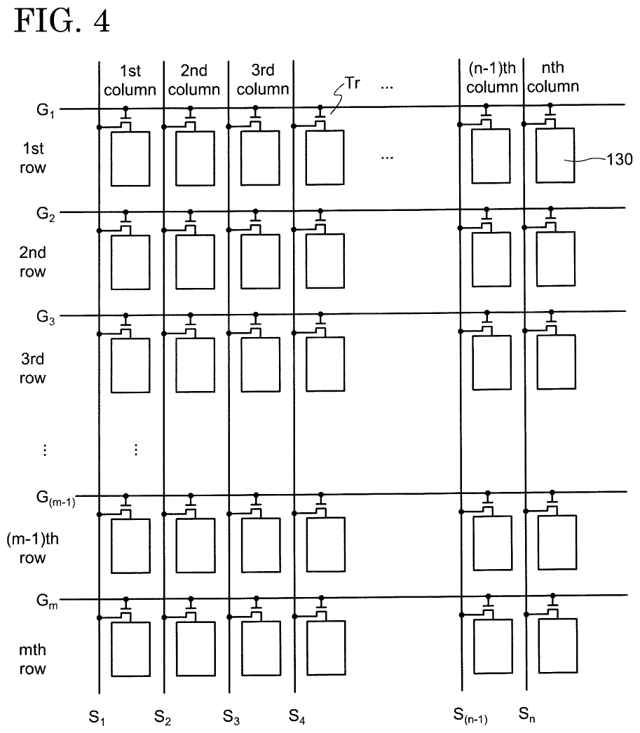

Hereinafter, a driving method of the intelligent reflecting surface 100 is explained. FIG. 4 shows a schematic top view showing the arrangement of the radio-wave reflection elements 130 in the intelligent reflecting surface 100. As described above, the plurality of radio-wave reflection elements 130 is arranged in a matrix shape with m rows and n columns. From the gate-line driver circuit 104, the gate lines G₁ to Gₘ extend to supply gate signals to the transistors Tr connected to the plurality of radio-wave reflection elements 130 arranged in the respective row. Furthermore, the source lines S1 to Sn extend from the signal-line driver circuit 106 to supply the control potentials to the transistors Tr connected to the plurality of radio-wave reflection elements 130 located in the respective column. The radio-wave reflection elements 130 located in each row are connected to the same gate line G via the element circuits, and the radio-wave reflection elements 130 located in each column are connected to the same source line S via the element circuits. Note that the transistor Tr shown in FIG. 4 is a switching transistor for controlling the on-off of each element circuit and may be the transistor 150 (see FIG. 2.) connected to the radio-wave reflection element 130 or may be a transistor different from the transistor 150. Thus, the transistor Tr may be connected directly to the radio-wave reflection element 130 or may be connected to the radio-wave reflection element 130 via another transistor or capacitor element. The element circuits are opened by supplying a gate potential to the gates of the transistors Tr via the gate line G, and the control potentials are supplied to the first electrodes 132 of the radio-wave reflection elements 130 via the signal lines S₁ to Sₙ.

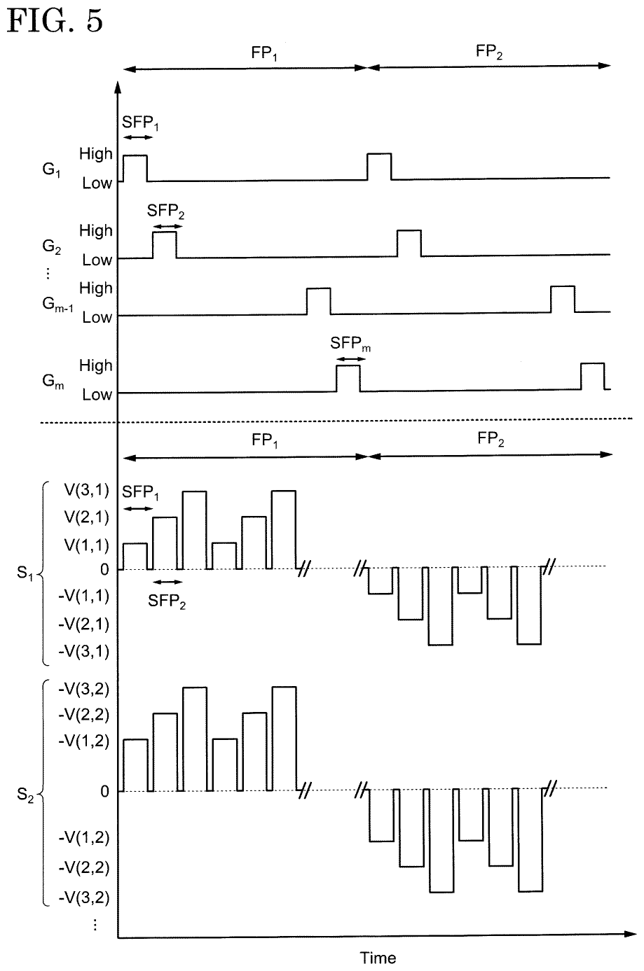

FIG. 5 shows an example of a timing chart illustrating this driving method. This chart shows the changes in potential applied to the gate line G and the signal line S over two frame periods having a fixed time (a first frame period FP₁ and a second frame period FP₂). The duration of each frame period FP is appropriately selected from a range of, for example, 1/60 second to 1 second. Each frame period FP is divided into m subframe periods SFP₁ to SFPₘ, and the control potentials are supplied to n radio-wave reflection elements 130 located in one row for writing in each subframe period SFP. Note that since the second electrode 140 is electrically floated, no potential is provided to the second electrode 140.

As can be understood from FIG. 5, the first to mth subframe periods SFP₁ to SFPₘ progress in sequence in one frame period FP, and the gate signal is supplied to one gate line G in each subframe period SFP. That is, the potential of the gate line G changes from a potential which turns off the transistor Tr (hereinafter, referred to as the potential Low for convenience) to a voltage which turns on the transistor Tr (hereinafter, referred to as the potential High for convenience). The gate signals are supplied in the order from the first gate line G₁ to the mth gate line Gₘ.

### (1) Prevention of Residual DC Voltage

While the potential High is supplied to one gate line G, the control potentials are supplied to the element circuits via the signal lines S₁ to Sₙ and applied to the first electrodes 132 of the radio-wave reflection elements 130 located in the row of the gate line G. The magnitudes of the control potentials are determined by the reflection direction of the radio waves incident on the intelligent reflecting surface 100. When the magnitudes of the control potentials are defined with respect to the reference potential of 0 V, the intelligent reflecting surface 100 is driven so that the summation of the control potentials of the first electrodes 132 which are simultaneously written in each subframe period SFP is 0 V (or substantially 0 V and ±0.1 V or less or ±0.2 V or less, for example). The same applies hereinafter). That is, the intelligent reflecting surface 100 is driven so that the summation of the control potentials supplied to the first electrodes 132 of the radio-wave reflection elements 130 located in each row is 0 V in each frame period FP. The reference potential may be, for example, the ground potential or the potential of the second electrode 140.

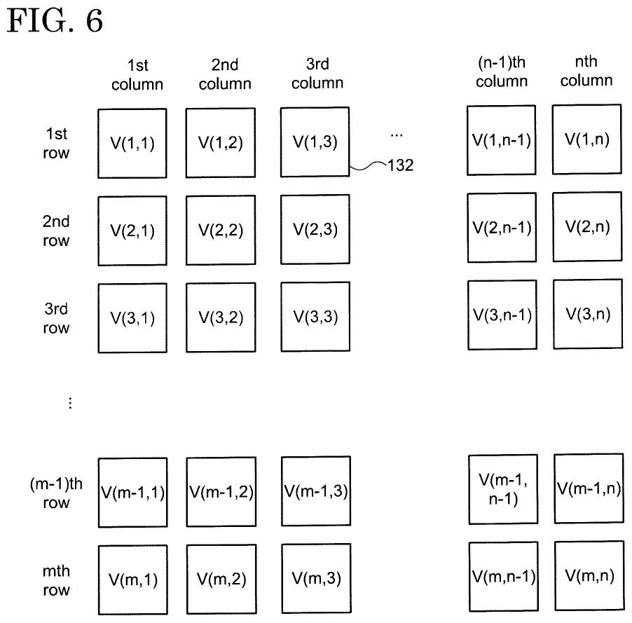

A more detailed explanation will be provided. Here, the control potential supplied to the first electrode 132 of the radio-wave reflection element 130 is defined as V(x, y) as shown in FIG. 6, where x and y are variables respectively representing row and column numbers, x is a natural number selected from 1 to m, and y is a natural number selected from 1 to n. In the first subframe period SFP₁, the potential of the gate line G₁ becomes High (see FIG. 5) and the control potentials V(1, 1) to V(1, n) are supplied to the first electrodes 132 from the signal-line driver circuit 106 via the signal lines S₁ to Sₘ. At this time, the summation of the control potentials V(1, 1) to V(1, n) is 0 V. In the subsequent second subframe period SFP₂, the potential of the gate line G₂ becomes High, and the control potentials V(2, 1) to V(2, n) are supplied from the signal-line driver circuit 106 via the signal lines S₁ to Sₘ. Again, the summation of control potentials V(2,1) to V(2, n) is OV. The same is applied to all of the rows. To generalize, in each frame period SF, a part of the control potentials V(x, 1) to V(x, n) provided to the first electrodes 132 of the radio-wave reflection elements 130 located in a xth row during the xth subframe period SFPx is positive with respect to the reference potential, the other part is negative with respect to the reference potential, and their summation is 0 V. The number of radio-wave reflection elements 130 with positive control potentials and that with negative control potentials are the same. Therefore, in one frame period FP, the summation of the control potentials V(1, 1) to V(m, n) provided to all of the first electrodes 132 is also 0 V. Note that, in each frame period FP, the summation of the control potentials (i.e., the summation of V(x, 1) to V(x, m)) provided to the first electrodes 132 of the radio-wave reflection elements 130 may or may not be 0 V in each column.

As described below, the so-called inversion driving is employed in the intelligent reflecting surface 100. If a small amount of ions is contained in the liquid crystal layer 136, the charge of the ions may accumulate to generate a bias component (DC component). However, since the intelligent reflecting surface 100 is driven so that the summation of the control potentials is 0 V in each row in each frame period as described above, the charges are canceled in the electrically floated second electrode 140. Therefore, there is no need to supply a signal to the second electrode 140 to adjust its potential to eliminate the DC component, which contributes to simplification of the structure of the intelligent reflecting surface 100 and reduction of manufacturing costs. In addition, since there is no need to supply signals or potentials to the second electrode 140, the burden on the external circuit during driving is reduced, thereby leading to a decrease in power consumption.

### (2) Control of Reflection Direction

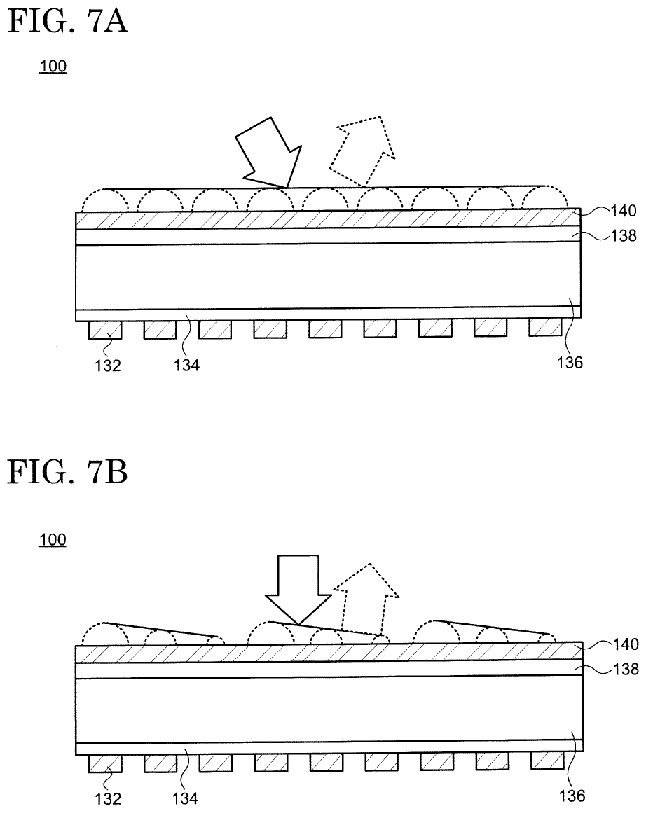

In the intelligent reflecting surface 100 having the structure described above, the first orientation film 134 and the second orientation film 138 orient the liquid crystal molecules in the same directions. Thus, when no potential difference is provided between the first electrode 132 and the second electrode 140, no vertical electric field is generated in the liquid crystal layer 136, and the liquid crystal molecules are splay-oriented. The orientation of the liquid crystal layer 136 is identical between the radio-wave reflection elements 130, and thus the permittivity is also constant within the liquid crystal layer 136. Therefore, the spread (phase) of the reflected radio waves generated when the radio waves incident on the second electrode 140 side (solid white arrow in FIG. 7A) are reflected at the surface of the first electrodes 132 does not change as represented by the dotted arcs in FIG. 7A. As a result, the incident radio waves are directly reflected by the intelligent reflecting surface 100, resulting in the reflected radio waves (dotted white arrow in FIG. 7A) with the same emission angle as the incident angle.

In contrast, when a potential difference is provided between the first electrode 132 and the second 140 electrode, the generated vertical electric field causes the liquid crystal molecules to rise and bend-orient. When the vertical electric fields of different intensities are generated between the radio-wave reflection elements 130, the permittivity of the liquid crystal layer 136 changes between the radio-wave reflection elements 130 according to the intensity of the vertical electric fields. As a result, the phase of the reflected radio waves changes as shown by the dotted arcs in FIG. 7B, resulting in a change of the reflection direction of the incident radio waves (solid white arrow in FIG. 7B) (see dotted white arrow in FIG. 7B). The reflection direction can be controlled by changing the intensity of the vertical electric fields formed in the radio-wave reflection elements 130.

When the reflection direction of the radio waves incident on the intelligent reflecting surface 100 is controlled, the orientation of the liquid crystal molecules in the liquid crystal layer 136 is controlled to periodically change the permittivity of the liquid crystal layer 136. The orientation of the liquid crystal molecules is determined by the absolute value of the control potential. Therefore, the absolute values of the control potentials are continuously and periodically increased or decreased in the row direction and/or the column direction in each frame period FP.

Specifically, when the control potentials are varied in the row direction, all of the radio-wave reflection elements 130 arranged in each row are divided into a plurality of element blocks including the same number of continuously arranged radio-wave reflection elements 130. The number of element blocks is even. Specifically, all of the radio-wave reflection elements 130 are divided into k element blocks each having continuously arranged j radio-wave reflection elements 130 in each row. Here, j is a natural number equal to or greater than 1, k is an even natural number equal to or greater than 2, and the product of j and k is n.

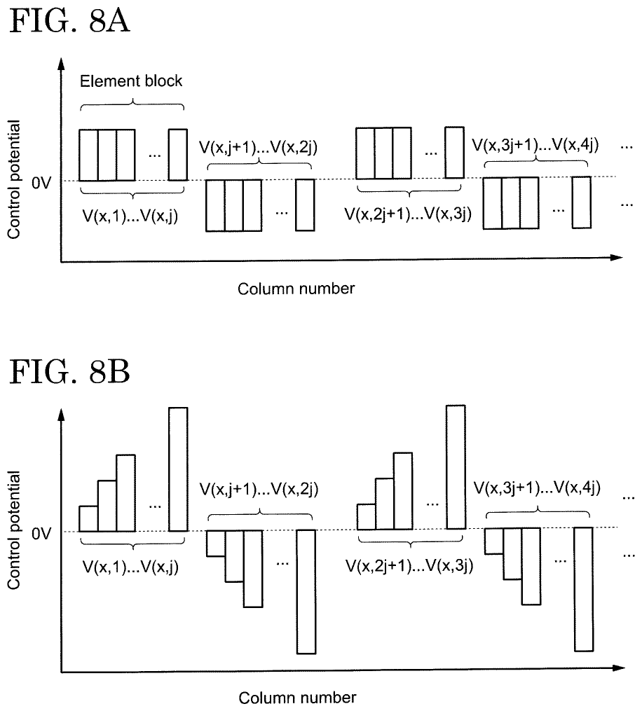

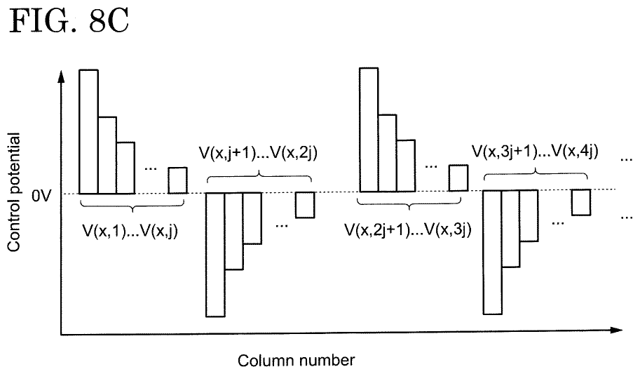

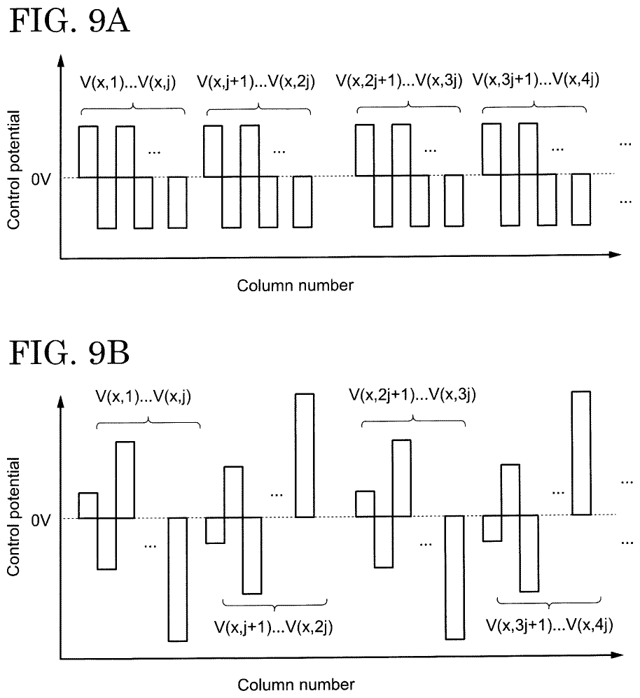

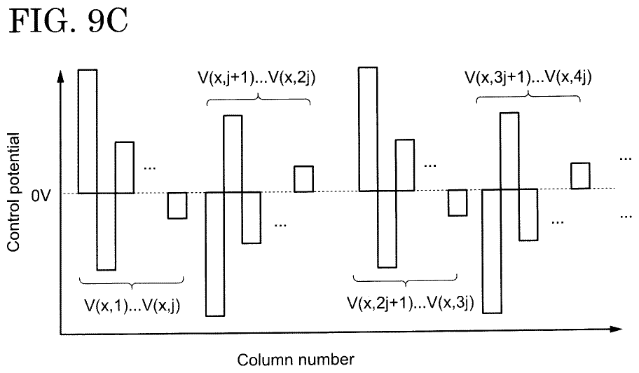

FIG. 8A to FIG. 11C schematically show the control potentials provided to the first electrodes 132 of the radio-wave reflection elements 130 arranged in one row (xth row) or one column (yth column). In this driving method, the absolute value of the control potential is further fixed (FIG. 8A) or is continuously increased or decreased according to the order of the columns (FIG. 8B and FIG. 8C) in each element block. When the absolute value of the control potential is fixed at a constant value, the absolute value of the control potential may be 0 V or may be greater or less than 0 V. Within each element block, the polarity of the control potential may be arbitrarily determined. Therefore, the polarity of the control potentials may be the same in each element block as shown in FIG. 8A to FIG. 8C or may be different as shown in FIG. 9A to FIG. 9C. In the former case, the polarity of the control potential may be the same between adjacent element blocks but is preferably reversed alternately. In the latter case, it is preferable to alternate the polarity of the control potential in each element block from column to column. The travelling distance of the charges causing the DC component is shortened, and the charges are more efficiently canceled by alternating the polarity. However, in each frame period FP, the intelligent reflecting surface 100 is driven so that the summation of control potentials is 0 V in each row as described above.

In order to make the reflection direction of the radio waves uniform within the intelligent reflecting surface 100, the magnitude of the control potential and its variation are preferred to be the same between the element blocks. In other words, it is preferred to drive the intelligent reflecting surface 100 so that, in each frame period FP, the absolute values of the control potentials provided to the first electrodes 132 of the radio-wave reflection elements 130 selected every j columns are the same and the polarity with respect to the reference potential alternates in each row. In other words, in each frame period FP, it is preferable to drive the intelligent reflecting surface 100 so that, in each row, the absolute value of the control potential is continuously increased or decreased, and continuously arranged j radio-wave reflection elements 130 can be selected.

For example, taking FIG. 8B and FIG. 9B as examples, the control potentials V(x, 1), V(x, j+1), V(x, 2j+1), and V(x, 3j+1) of the first column, the (j+1)th column, the (2j+1)th column, and the (3j+1)th column have the same absolute value but alternate in polarity (i.e., the polarity is inverted in the column order). In addition, in each x row. the absolute values of the control potentials continuously increased, and the radio-wave reflection elements 130 provided with the control potentials V(x, 1) to V(x, j) and the radio-wave reflection elements 130 provided with the control potentials V(x, j+1) to V(x, 2j) can be selected as the continuously arranged radio-wave reflection elements 130, for example. The radio waves can be reflected in a direction rotated about an axis parallel to the row direction by driving the intelligent reflecting surface 100 in this manner. Note that FIG. 8A and FIG. 9A represent the case where j is 1. Since the absolute values of the control potentials are the same in each row, and the intensity of the vertical electric field generated in the liquid crystal layer 136 is also constant in this case, the radio waves are directly reflected when viewed from the row direction.

The same is applied when the control potential is varied in the column direction. That is, all the radio-wave reflection elements 130 are divided into continuously arranged h element blocks including g radio-wave reflection elements 130 in each column. Here, g and h are each independently a natural number equal to or greater than 1, and the product of g and his m. The number h of element blocks may be even or odd. However, when the intelligent reflecting surface 100 is driven so that the summation of the control potentials provided to the first electrodes 132 of the radio-wave reflection elements 130 arranged in each column is 0 V in each frame period SF, the number h of element blocks is set to be even.

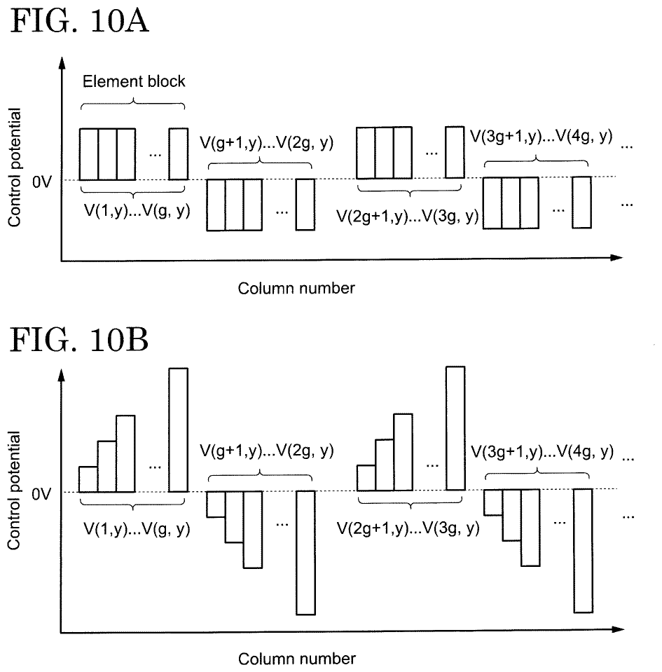

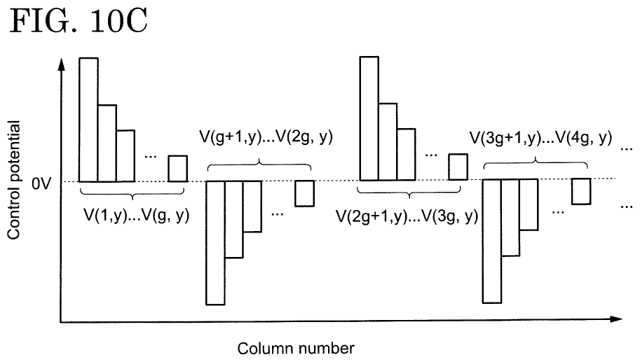

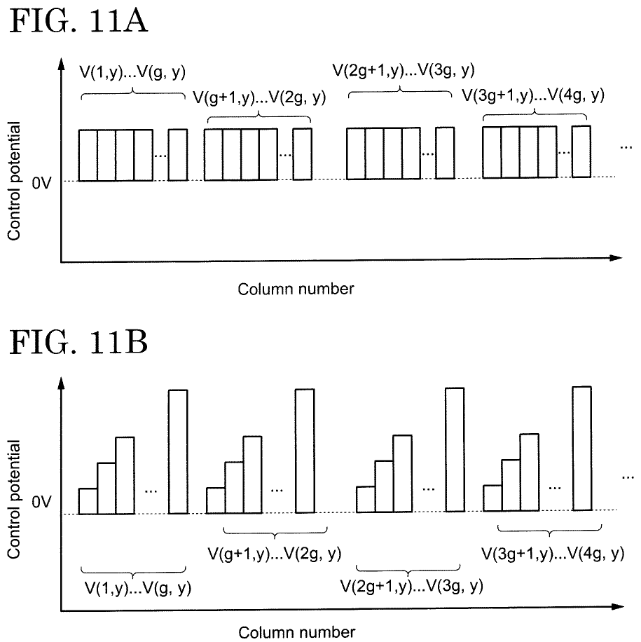

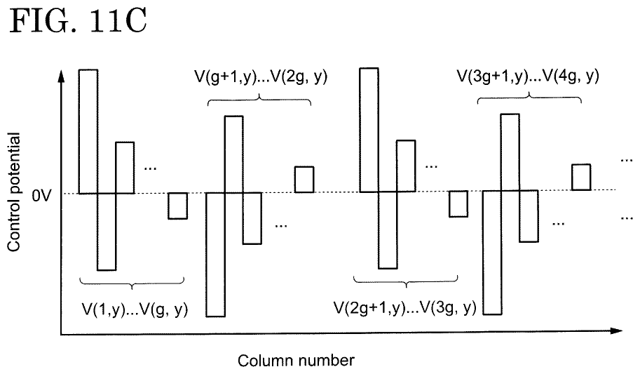

Furthermore, the absolute values of the control potentials are fixed within each element block (FIG. 10A) or are sequentially increased or decreased according to the order of rows (FIG. 10B, FIG. 10C). Within each element block, the polarity of the control potential may be arbitrarily determined. In each element block, the polarity of the control potential may be the same as shown in FIG. 10A to FIG. 10C, or the polarity of the control potential may be the same in all of the element blocks as shown in FIG. 11A and FIG. 11B. Alternatively, the polarity of the control potentials may be different in each element block as shown in FIG. 11C. When the polarities of the control potentials are the same in each element block, it is preferred to set h to be an even number and invert the polarity of the control potential between adjacent element blocks (FIG. 10A to FIG. 10C). When the polarities of the control potentials are different in each element block, it is preferable to alternate the polarity of the control potential row-by-row in each element block (FIG. 11C), by which the travelling distance of the charges causing the DC component can be decreased, and the charges can be more efficiently canceled.

In addition, similar to the control in the row direction, it is preferred to drive the intelligent reflecting surface 100 so that, in each frame period, the absolute values of the control potentials provided to the first electrodes 132 of the intelligent reflecting surfaces 130 selected every g rows are the same as each other in each column in order to make the reflection direction of radio waves uniform in the intelligent reflecting surface 100. In other words, it is preferable to drive the intelligent reflecting surface 100 so that, in each frame period FP, the absolute values of the control potentials are continuously increased or decreased, and continuously arranged radio-wave reflection elements 130 can be selected in each column.

For example, taking FIG. 10B and FIG. 11B as examples, the absolute values of the control potentials V(1, y), V(g+1, y), V(2g+1, y), and V(3g+1, y) of the first row, the (g+1)th row, the (2g+1)th row, and the (3g+1)th row are identical. The polarities of these control potentials may alternate (i.e., the polarity is inverted in the row order) (FIG. 10B) or may be constant (FIG. 11B). In the yth row, the absolute values of the control potentials are continuously increased, and the radio-wave reflection elements 130 provided with the control potentials V(1, y) to V(g, y) and the radio-wave reflection elements 130 provided with the control potentials V(2g, y) to V(g+1, y) can be selected as the continuously arranged radio-wave reflection elements 130, for example. The radio waves can be reflected in a direction rotated about an axis parallel to the column direction by driving the intelligent reflecting surface 100 in this manner. Note that FIG. 10A and FIG. 11a represent the case where g is 1. Since the control potential is the same in each column, and the intensity of the vertical electric field generated in the liquid crystal layer 136 is constant in this case, the radio waves are directly reflected when viewed from the row direction.

The aforementioned driving method makes it possible to arbitrarily control the reflection direction of incident radio waves in both the row direction and the column direction while preventing the generation of the DC component.

### (3) Inversion Driving

In driving the intelligent reflecting surface 100, the so-called inversion driving is employed to prevent a phenomenon called burn-in, in which the orientation of the liquid crystal molecules is temporarily fixed due to an accumulation of ionic components and polarization of the liquid crystal molecules. That is, the intelligent reflecting surface 100 is driven so that the direction of the vertical electric field generated in the liquid crystal layer 136 is inverted every frame period FP. Specifically, the control potential provided to each first electrode 132 in one frame period (first frame period FP₁) is inverted with respect to the reference potential in the subsequent frame period (second frame period FP₂) as shown in FIG. 5. Therefore, when the reference potential is 0 V, the potential V(x, y) provided to the first electrode 132 of the radio-wave reflection element 130 in the xth row and the yth column in the first frame period FP₁ is inverted in polarity in the second frame period FP₂ to become the potential −V(x, y). By employing the inversion driving, charge accumulation and polarization of the liquid crystal molecules caused by a small amount of impurities in the liquid crystal layer 136 can be prevented and burn-in can be prevented.

As described above, the second electrode 140 opposing the patch electrodes (first electrode 132) provided with the control potential is electrically floated in the plurality of radio-wave reflection elements 130 arranged in m rows and n columns in the intelligent reflecting surface 100. In addition, the intelligent reflecting surface 100 is driven so that, in each frame period FP, the summation of the control potentials provided to the first electrodes 132 of the radio-wave reflection elements 130 is 0 V in each row. Therefore, the charges causing the generation of the DC component are cancelled in the electrically floating second electrode 140, and no adjustment of the potential of the second electrode 140 is required. Therefore, implementation of an embodiment of the present invention enables the production of an intelligent reflecting surface having a simplified structure at a low cost. It is also possible to provide an intelligent reflecting surface capable of being driven with low power consumption.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the radio-wave reflection element or the intelligent reflecting surface or is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A driving method of an intelligent reflecting surface comprising:
a plurality of radio-wave reflection elements arranged in a matrix shape with m rows and n columns, each of the plurality of radio-wave reflection elements comprising a first electrode, a liquid crystal layer over the first electrode, and an electrically floated second electrode over the liquid crystal layer, the driving method comprising:
providing the first electrode with a control potential with respect to a reference potential without providing a potential to the second electrode in a first frame period,
wherein a summation of the control potentials provided to the first electrodes of the plurality of radio-wave reflection elements is 0 V in the first frame period, and
m and n are independently selected from natural numbers equal to or greater than 6, and n is an even number.

2. The driving method according to claim 1,
wherein the summation of the control potentials is 0 V in each row in the first frame period.

3. The driving method according to claim 1,
wherein, in each row, all of the plurality of radio-wave reflection elements is divided into k element blocks including continuously arranged j radio-wave reflection elements,
in the first frame period, the control potentials provided to the first electrodes of the radio-wave reflection elements selected from every j columns are the same in absolute value as each other and alternate in polarity with respect to the reference potential in each row, and
j is a natural number equal to or greater than 1, and k is a natural number equal to or greater than 2.

4. The driving method according to claim 3,
wherein, in the first frame period, the absolute values of the control potentials continuously increase or decrease in an order of the columns in each element block.

5. The driving method according to claim 1,
wherein, in each column, all of the plurality of radio-wave reflection elements is divided into h element blocks including continuously arranged g radio-wave reflection elements,
in the first frame period, the control potentials provided to the first electrodes of the radio-wave reflection elements selected from every g rows are the same in absolute value as each other in each column, and
g is a natural number equal to or greater than 1, h is a natural number equal to or greater than 2, and a product of g and h is m.

6. The driving method according to claim 5,
wherein, in the first frame period, the control potentials provided to the first electrodes of the radio-wave reflection elements selected from every g rows alternate in polarity with respect to the reference potential in each column.

7. The driving method according to claim 5,
wherein, in the first frame period, the absolute values of the control potentials continuously increase or decrease in an order of the rows in each element block.

8. The driving method according to claim 1, further comprising inverting the control potentials with respect to the reference potential in a second frame period following the first frame period.

9. The driving method according to claim 1,
wherein the first frame includes a first sub-frame period to a mth sub-frame period, and
the control potentials are provided to the first electrodes arranged in a first row to a mth row in the first sub-frame period to the mth sub-frame period, respectively.

10. An intelligent reflecting surface comprising:
a plurality of radio-wave reflection elements arranged in a matrix shape with m rows and n columns (m and n are independently selected from natural numbers equal to or greater than 6, and n is an even number),
wherein each of the plurality of radio-wave reflection elements comprises a first electrode, a liquid crystal layer over the first electrode, and an electrically floated second electrode over the liquid crystal layer.

11. The intelligent reflecting surface according to claim 10,
wherein each of the plurality of radio-wave reflection elements further comprises:
a first orientation film between the first electrode and the liquid crystal layer; and
a second orientation film between the liquid crystal layer and the second electrode.

12. The intelligent reflecting surface according to claim 10,
wherein the second electrode is configured not to be supplied with a signal from an external circuit.

13. The intelligent reflecting surface according to claim 11, further comprising a substrate and a counter substrate respectively located over and under the plurality of radio-wave reflection elements,
wherein the second electrode is sealed between the second orientation film and the counter substrate.
